(19) United States
(12) Patent Application Publication
(10) Pub. No.: US 2023/0359022 A1
(43) Pub. Date: Nov. 9, 2023

(54) DEFLECTION DEVICE WITH A MIRROR FOR USE IN SCANNER TECHNICAL FIELD

(71) Applicants: HUAWEI TECHNOLOGIES CO., LTD., Shenzhen (CN); FRAUNHOFER-GESELLSCHAFT ZUR FOERDERUNG DER ANGEWANDTEN FORSCHUNG E.V., Munich (DE)

(72) Inventors: Frank Senger, Itzehoe (DE); Ulrich Hofmann, Itzehoe (DE); Stephan Marauska, Itzehoe (DE); Christian Janicke, Itzehoe (DE); Thomas Von Wantoch, Itzehoe (DE); Joerg Albers, Itzehoe (DE); Gunnar Wille, Itzehoe (DE); Yong Cao, Munich (DE)

(21) Appl. No.: 18/196,686

(22) Filed: May 12, 2023

Related U.S. Application Data
(63) Continuation of application No. PCT/EP2020/081823, filed on Nov. 12, 2020.

(51) Int. Cl. G02B 26/10; G02B 26/08

(52) U.S. Cl. CPC G02B 26/101; G02B 26/0841; G02B 26/0858; G02B 26/085

(57) ABSTRACT

The present disclosure provides a deflection device (100, 200, 300, 400) for use in a scanner. The deflection device (100, 200, 300, 400) includes a substrate (102, 202), a mirror (106, 206, 304, 404) and actuator means (110). The mirror (106, 206, 304, 404) arranged in a recess (104, 204, 306, 406) in the substrate (102, 202) by connector means (108) in such a way that it can rotate about at least two axes in an oscillatory manner. The actuator means (110) causes the mirror (106, 206, 304, 404) to oscillate. The actuator means (110) are arranged in one or more trenches (112A-D) in the substrate (102, 202) surrounding the recess (104, 204, 306, 406), in such a way that a change of shape of the actuator means (110) will cause a movement in the substrate (102, 202), thereby inducing oscillatory movement of the mirror (106, 206, 304, 404).

### TECHNICAL FIELD

The present disclosure relates generally to optical devices and more specifically, to a deflection device that includes a mirror for use in a scanner.

### BACKGROUND

In optics, MEMS (Micro-Electrical-Mechanical-System) technology has been an enabling tool for numerous cutting-edge devices for optical communication. A deflection device or a scanner based on MEMS technology is capable of two-dimensional optical scanning and plays a vital role in various low-power and compact scanning applications, including projection, sensing, and imaging. Typically for use in scanners and such, deflection devices are used. For a scanned laser projection system, larger amplitudes are equivalent to a higher optical resolution. Thus, laser projection based upon resonant operation of the (micro electro mechanical system) MEMS mirror is widely adopted. The deflection of the light along two axes may be achieved using a gimbal mounting of the mirror. A scan angle of a deflection device may be equivalent to twice of a mechanical rotation angle of a mirror. The mirror may be coupled to springs and mechanically stabilised in a chip structure and enabled to oscillate along at least two axes. The mirror is driven by either internal actuators or by using an external driving mechanism with actuators that connect the MEMS mirrors to form a coupled oscillation system.

In case of the internal actuators, the mirror oscillation amplitude can be exploited with typically using piezoelectric elements. A piezoelectric layer is deposited on to springs that are coupled to the mirror, which causes mirror movement on elongation or contraction of the piezoelectric layer and hence causing deflection of the springs. The area for depositing the piezoelectric layer is limited by the geometry of the spring. The maximum achievable forces for deflection, which scale with the area, cannot be independently controlled from the springs. This leads to restrictions in the scan angle. The scan angle is an optical angle that a deflection device or a scanner based on MEMS technology may normally achieve at a given rate of points per second.

External driving mechanisms with actuators that connect with MEMS mirrors have a higher space requirement. The scan angle gets wider, and a larger area is covered by the deflection device but there is an increased difficulty for the deflection device to scan accurately due to the physical limitations of the external driving mechanism, also the deflection device gets bulky. Moreover, such an external driving mechanism with actuators is relatively expensive. Also, precision and control of movement of the mirror become more difficult and there is a significant loss of energy during an activation mechanism as well.

Common drawbacks to the aforementioned deflection device include not being functional in achieving a greater value of the scan angle and at the same time, having a larger space requirement for the deflection device and more time as well as cost requirement for manufacturing process of the deflection device.

Therefore, in light of the foregoing discussion, there exists a need to address the aforementioned drawbacks in existing technologies to achieve a greater value of the scan angle for the deflection device with lesser space requirement as compared to the traditional deflection device of prior-art.

### SUMMARY

It is an object of the present disclosure to provide a deflection device that enables higher scan angles and provides both actuation and sensing in a same manufacturing process which causes lower cost of the manufacturing process compared to a traditional deflection device having internal actuation or external driving mechanism.

This object is achieved by features of the independent claims. Further, implementation forms are apparent from the dependent claims, the description, and the figures.

According to a first aspect, there is provided a deflection device for use in a scanner. The deflection device includes a substrate, a mirror and actuator means. The mirror is arranged in a recess in the substrate and connected to the substrate by connector means in such a way that it can rotate about at least two axes in an oscillatory manner. The actuator means causes the mirror to oscillate. The actuator means are arranged in one or more trenches in the substrate surrounding the recess, in such a way that a change of shape of the actuator means will cause a movement in the substrate, thereby inducing oscillatory movement of the mirror. The deflection device has an advantage in achieving oscillation of the substrate to the same or similar frequency as that of a resonance frequency of the mirror. The deflection device has no limitation of an area caused by spring geometry at the connector means. Therefore, the deflection device enables larger achievable scan angles by utilizing higher available actuation energy via the actuator means with larger effective actuation area. The scanners of high resolution require a very large scanning angle and that may be achieved without the mechanical stress due to the advantageous design of the deflection device.

The mirror may be a MEMS mirror. The mirror may enable the deflection device to achieve nanometre level precision in scanning applications.

In a first possible implementation form of the deflection device of the first aspect, the actuator means is arranged to change its shape in response to an electrical signal. The actuator means optionally includes one or more piezo-electric elements controlled by a voltage signal. The one or more piezo-electric elements provides higher scan angles compared to the traditional deflection device. Optionally, the actuator means includes one or more electrostatic comb elements controlled by a voltage signal. The actuator means may include one or more magnetic force stimulation elements controlled by a current signal. This electrostatic comb element or magnetic force stimulation element enables the deflection device with externally excitable internal actuation.

In a second possible implementation form of the deflection device of the first aspect, a mass element is arranged under the actuator means in at least one of the one or more trenches. The mass element provides the deflection device with vertical actuation and/or also provides phase-shifted actuation of a piezo-electric element that induces rotational oscillation of the deflection device.

The connector means optionally includes one or more springs attached by one end to the mirror and the other end to the substrate surrounding the recess. The one or more springs enables the deflection device to achieve higher scan angles.

In a third possible implementation form of the deflection device of the first aspect, a piezo-electric element is attached to at least one of the springs for detecting an orientation of the mirror, and generating a signal representative of the orientation to control means arranged to control the actuator means. The deflection device achieves both actuation and sensing in the same manufacturing process, which result in a lower cost of manufacturing process.

The actuator means optionally includes four actuator elements positioned the corners of a rectangle around the recess. The four actuator elements may induce rotational oscillation of the deflection device. Optionally, the actuator means include at least three curved actuator elements each covering a segment of circumference around the recess.

According to a second aspect, there is provided a light engine for an augmented reality or virtual reality (AR/VR) device that includes a laser emitting device, one or more optical elements arranged to shape a laser beam emitted from the laser emitting device, a deflection device according to the present disclosure arranged to project the shaped laser beam onto a reflection surface. The deflection device displays an image to a user of the augmented reality or virtual reality device (AR/VR) device.

According to a third aspect, there is provided a display device for augmented reality or virtual reality that includes one or more light engines. The one or more light engines provides lighting of an active scene/object or projection of information to a surface.

A technical problem in the prior art is resolved, where the technical problem is that the area for applying a piezoelectric thin film is limited by the spring geometry for an internal actuation. Due to the spring geometry for the internal actuation, the maximum achievable forces in the traditional deflection device cannot be independently controlled from the spring. This leads to restrictions in the scan angle. Another technical problem in the prior art is resolved, where the technical problem is that in the case of external actuation, a hybrid driving mechanism has higher space requirements and is relatively expensive.

Therefore, compared with the prior art, according to the deflection device with a mirror that is actuated using actuator means may have a smaller footprint compared to a traditional deflection device having internal actuation or external driving mechanism. The deflection device may have a higher integration factor as well. The deflection device enables both actuation and sensing in the same manufacturing process which cause a lower cost of the manufacturing process compared to the traditional deflection device having internal actuation or external driving mechanism. The deflection device has higher lifetime reliability compared to the traditional deflection device having internal actuation or external driving mechanism. The deflection device has more design flexibility for actuation structures as it utilizes a periphery of the deflection device. Whereas the traditional deflection device having internal actuation or external driving mechanism has limited space because of moving parts that may be attached with the mirror of the traditional deflection device having internal actuation or external driving mechanism.

The present disclosure substantially eliminates or at least partially address the aforementioned technical drawbacks in existing technologies for achieving a greater scan angle in deflection devices with lesser space requirements as compared to the traditional deflection device of prior-art. The actuator means of the deflection device may be used in automotive, consumer, and industrial applications where arrangements may be fabricated by typical semiconductor processes.

These and other aspects of the present disclosure will be apparent from and the implementation(s) described below.

### BRIEF DESCRIPTION OF THE DRAWINGS

To illustrate the technical solutions in the implementations of the present disclosure or the prior art more clearly, the following briefly introduces the accompanying drawings required for describing the implementations of the prior art. Apparently, the accompanying drawings in the following description show merely some implementations of the present disclosure, and a person of ordinary skill in the art may still derive other drawings from these accompanying drawings without creative efforts.

FIG. 1A shows a deflection device, in accordance with an implementation of the present disclosure;

FIG. 1B is a cross-sectional view of the deflection device illustrated in FIG. 1A, in accordance with an implementation of the present disclosure;

FIG. 2A is a schematic diagram that illustrates a perspective view of a first exemplary integration of a deflection device that includes one or more trenches having actuator elements, in accordance with an implementation of the present disclosure;

FIGS. 2B and 2C illustrate a top-view and a bottom auxiliary view respectively of the first exemplary integration of the deflection device of FIG. 2A that includes the one or more trenches having the actuator elements in accordance with an implementation of the present disclosure;

FIGS. 3A and 3B illustrate a top-view and a bottom auxiliary view respectively, of a second exemplary integration of a deflection device that includes one or more trenches having actuator elements in accordance with an implementation of the present disclosure;

FIGS. 4A and 4B illustrate a top-view and a bottom auxiliary view respectively, of a third exemplary integration of a deflection device that includes the one or more trenches having actuator elements in accordance with an implementation of the present disclosure;

FIG. 5 is a schematic illustration of a product that uses the deflection device in accordance with an implementation of the present disclosure; and

FIG. 6 is a flow-chart that describes a method of externally exciting a mirror using an auxiliary internal piezo actuator placed beside a mirror structure in accordance with an implementation of the present disclosure

### DETAILED DESCRIPTION OF THE DRAWINGS

Implementations of the present disclosure provide a deflection device that enables higher scan angles and both actuation and sensing in a same manufacturing process which causes lower cost of the manufacturing process.

To make the solutions of the present disclosure more comprehensible for a person skilled in the art, the following clearly and completely describes the technical solutions in the implementations of the present disclosure with reference to the accompanying drawings in the implementations of the present disclosure. Apparently, the described implementations are merely a part rather than all of the implementations of the present disclosure. All other implementations obtained by a person of ordinary skill in the art based on the implementations of the present disclosure without creative efforts shall fall within the protection scope of the present disclosure.

Terms such as “a first”, “a second”, “a third”, and “a fourth” (if any) in the summary, claims, and foregoing accompanying drawings of the present disclosure are used to distinguish between similar objects and are not necessarily used to describe a specific sequence or order. It should be understood that the terms so used are interchangeable under appropriate circumstances, so that the implementations of the present disclosure described herein are, for example, capable of being implemented in sequences other than the sequences illustrated or described herein. Furthermore, the terms “include” and “have” and any variations thereof, are intended to cover a non-exclusive inclusion. For example, a process, a method, a system, a product, or a device that includes a series of steps or units, is not necessarily limited to expressly listed steps or units, but may include other steps or units that are not expressly listed or that are inherent to such process, method, product, or device.

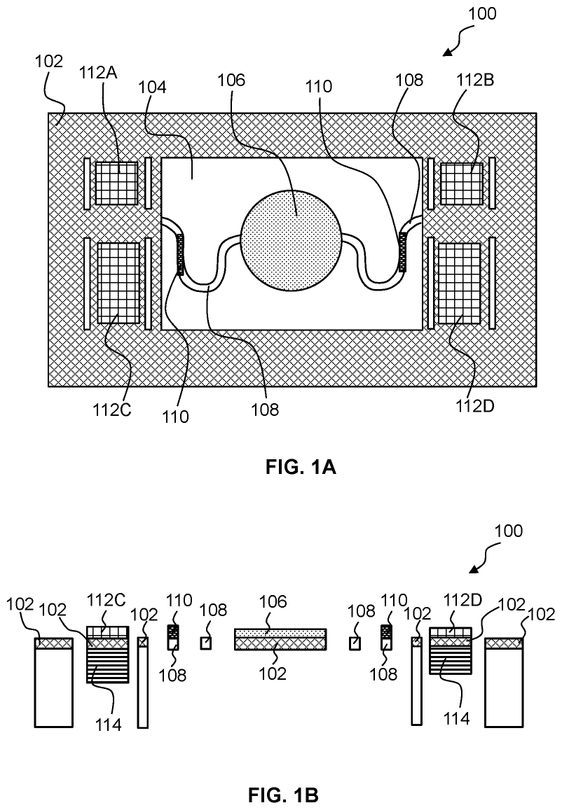

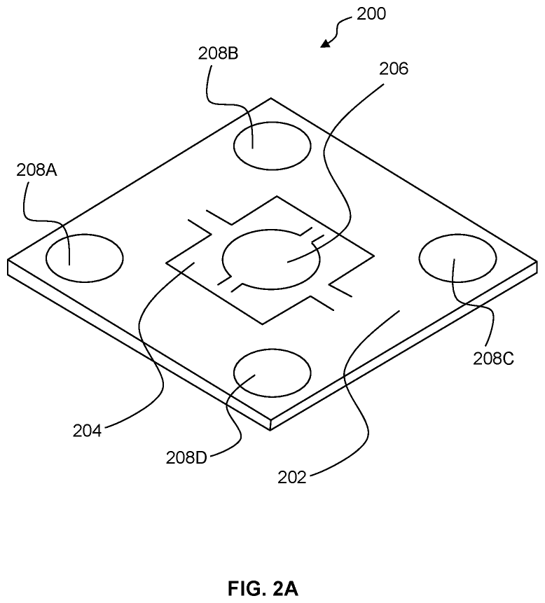

FIG. 1A shows a deflection device 100 in accordance with an implementation of the present disclosure. The deflection device 100 includes a substrate 102, a recess 104, a mirror 106, connector means 108, actuator means 110, and one or more trenches 112A-D. The mirror 106 is arranged in the recess 104 of the substrate 102 and connected to the substrate 102 by the connector means 108, in such a way that the mirror 106 rotates about at least two axes in an oscillatory manner.

The actuator means 110 cause the mirror 106 to oscillate when actuated. The actuator means 110 are arranged in the one or more trenches 112A-D in the substrate 102 surrounding the recess 104, in such a way that a change in shape of the actuator means 110 will cause movement in the substrate 102, thereby inducing oscillatory movement in the mirror 106.

The substrate 102 may be a thin slice of semiconductor, such as a crystalline silicon (c-Si), used for fabrication of integrated circuits and, in photovoltaics, to manufacture, for example, solar cells. An area of the substrate 102 that may not have direct contact with the mirror 106 and the connector means 108 may be fitted with actuator means 110 to bring about actuation of the mirror 106 and the connector means 108.

The mirror 106 may be a micro electro mechanical system (MEMS) mirror. The MEMS mirror may be a dual-axis mirror, for example, may be a micro-scanner, or any other bi-axial scanner, etc. Micro-electro mechanical system (MEMS) may refer to devices that are very small in size ranging from a few micrometres to the millimetre, which combine both mechanical and electrical components and that are fabricated using integrated circuit batch processing technologies. The MEMS mirror may be a micro-electro mechanical system (MEMS) in a category of mirror actuators for dynamic light modulation. The movement of the mirror 106 may be on two axes where an incident light may be deflected.

The mirror 106 may be a 3D-MEMS mirror which reflects a laser ray projected onto it by an associated collimator. In an example implementation, mirror arrays are replaced by arrays of steerable 3D-MEMS mirrors which reflect the laser ray projected onto them by an associated collimator. The mirror 106 may be rotated about the two axes in an oscillatory manner. The mirror 106 may be rotated by under vacuum by wafer-level hermetic packaging technique.

The deflection device 100 may include a silicon device with a millimetre-scale mirror at the center. The mirror 106 may be connected to flexures. The flexures may be flexible elements arranged to allow the mirror 106 to oscillate on a single axis or oscillate bi-axially, to project or capture light. The mirror 106 and the connector means 108 may be suspended in the gimbal structure. The mirror 106 may be in a close-loop control that may be activated by achieving a position detection. The mirror 106 in a close loop control may be activated by the actuator means 110 coated on the connector means 108.

FIG. 1B is a cross-sectional view of the deflection device 100 illustrated in FIG. 1A, in accordance with an implementation of the present disclosure. The deflection device 100 includes the substrate 102, the mirror 106 that is arranged in the recess 104, the one or more trenches 112A-D in the substrate 102 surrounding the recess 104, and optionally, a mass element 114. The connector means 108 include one or more springs attached by one end to the mirror 106 and another end to the substrate 102 surrounding the recess 104.

The actuator means 110 are arranged in the one or more trenches 112A-D in the substrate 102 surrounding the recess 104, in such a way that a change of shape of the actuator means 110 will cause a movement in the substrate 102, thereby inducing oscillatory movement of the mirror 106. The actuator means 110 may be arranged to change its shape in response to an electrical signal. The actuator means 110 may be set into oscillation at the same or similar to a frequency as that of a resonance frequency of moving structures, e.g. the mirror 106 and the connector means 108. Actuation energy of the actuator means 110 may couple via. the substrate 102 into the mirror 106 and the connector means 108, thereby bringing about greater effective actuation area.

The actuator means 110 optionally includes one or more piezo-electric elements actuated by a voltage signal. Piezo-electric nature of a material is an ability of certain materials to generate an electric charge in response to applied mechanical stress. The one or more piezo-electric elements may be defined as materials that produce an electric current when they are placed under mechanical stress. A piezo-electric process may be reversible, so if the electric current is applied to the one or more piezo-electric elements, they change shape slightly (e.g. a maximum of 4%). The one or more piezo-electric elements may include proteins, crystals, and ceramics, e.g. lead zirconate titanate.

Optionally, the actuator means 110 include one or more electrostatic comb elements controlled by a voltage signal. The actuator means 110 may include one or more magnetic force stimulation elements controlled by a current signal. This electrostatic comb element or the magnetic force stimulation element enables the deflection device 100 with externally excitable internal actuation.

The one or more trenches 112A-D are cavities in the substrate 102 surrounding the recess 104. A trench may be a cavity such as a space in the deflection device 100 that accommodates the actuator means 110 or a movement of the actuator means 110. The one or more trenches 112A-D may be design-optimized and patterned to achieve a required scan angle. The one or more trenches 112A-D may be fitted with actuator elements, including but not limited to, the one or more piezo-electric elements. The one or more piezo-electric elements may be arranged as functional layers in the one or more trenches 112A-D. The functional layers may include translational or vertical actuation with respective eigenfrequencies of the mirror axis that may resonate with the deflection device 100. The piezo-electric elements actuation may lead to a resonance of the substrate 102.

The mass element 114 may be arranged under the actuator means 110 in at least one of the one or more trenches 112A-D. In an example implementation, the one or more trenches 112A-D include an additional mass element fitted below the actuator means 110. The actuator elements may be attached to at least one spring of the connector means 108 for detecting the orientation of the mirror 106. The actuator elements attached to the at least one spring may also be used for generating a signal representative of the orientation to a control device arranged to control the actuator means 110.

The actuator means 110 is optionally connected to additional oscillatory functional layers that may be arranged in the one or more trenches 112A-D. The additional oscillatory functional layers provide additional functionality of the mirror 106 to the deflection device 100. The actuator means 110 may be an actuator mechanism located inside the deflection device 100 beside the recess 104 into which the mirror 106 is suspended, which provides the force to the deflection device 100 for scanning and can be excited using electrostatic, magnetic, or piezo-electric principles. The actuator mechanism from the change of shape of the actuator means 110 may cause vibratory excitation of the deflection device 100 or tilting movement of a gimbal structure and the mirror 106 respectively. The actuator mechanism may be used in automotive, consumer, or industrial applications which are fabricated by typical semiconductor processes.

The deflection device 100 has induced vibration with the resonance frequency of a driven axis and leads to oscillation of the mirror 106, in such a way that it can rotate about at least two axes in an oscillatory manner. Due to the actuation frequency being substrates eigenfrequency, constructive interference of the mirror 106 and the substrate 102 movement may lead to high angle oscillation of the mirror 106. Through a phase and an amplitude corresponding to the piezo-electric elements that are driven, the amplitude of the mirror 106 may be controlled.

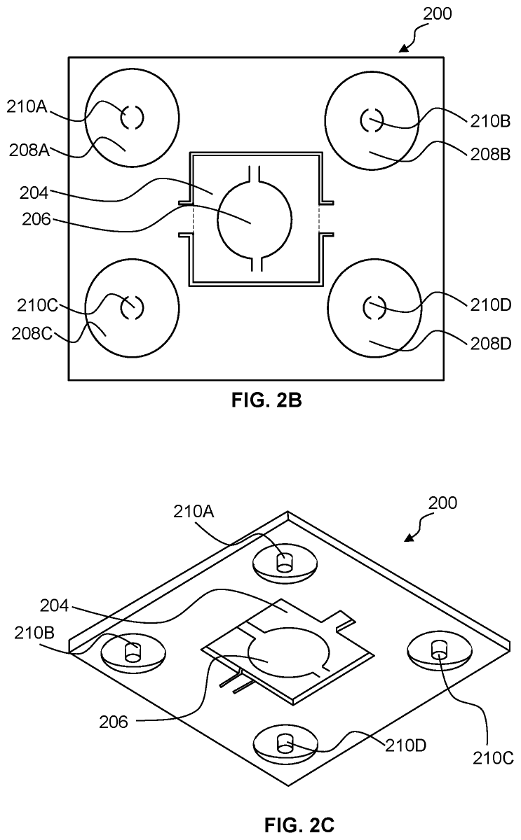

FIG. 2A illustrates a perspective view of a first exemplary integration of a deflection device 200 that includes one or more trenches having actuator elements 208A-D, in accordance with an implementation of the present disclosure. The first exemplary integration of the deflection device 200 includes a mirror 206 that is arranged in a recess 204 and the one or more trenches having the actuator elements 208A-D in a substrate 202 surrounding the recess 204. The actuator elements 208A-D may include, but be not limited to, piezo-electric elements. Actuation of the one or more trenches having the actuator elements 208A-D may cause vibration in the first exemplary integration of the deflection device 200. The vibration with respect to a resonance frequency leads to an oscillation of the mirror 206. Either an amplitude or a frequency of the mirror 206 may be controlled using a phase and an amplitude of a signal wave. Using the signal wave, the one or more trenches having the actuator elements 208A-D may be driven.

FIGS. 2B and 2C illustrate a top-view and a bottom auxiliary view respectively, of the first exemplary integration of the deflection device 200 of FIG. 2A that includes the one or more trenches having actuator elements 208A-D in accordance with an implementation of the present disclosure. The first exemplary integration of the deflection device 200 depicts one or more round piezo-electric arrangements 210A-D, one or more trenches having the actuator elements 208A-D, the recess 204, and the mirror 206. The one or more round piezo-electric arrangements 210A-D may include a mass element attached at bottom of the one or more trenches having the actuator elements 208A-D to actuate vertical direction, phase-shifted actuation of the one or more trenches. The phase-shifted actuation of the one or more trenches induces rotational oscillation of the deflection device 200. The one or more round piezo-electric arrangements 210A-D, as four actuator elements, may be positioned at corners of the first exemplary integration of the deflection device 200 around the recess 204 to form actuator means.

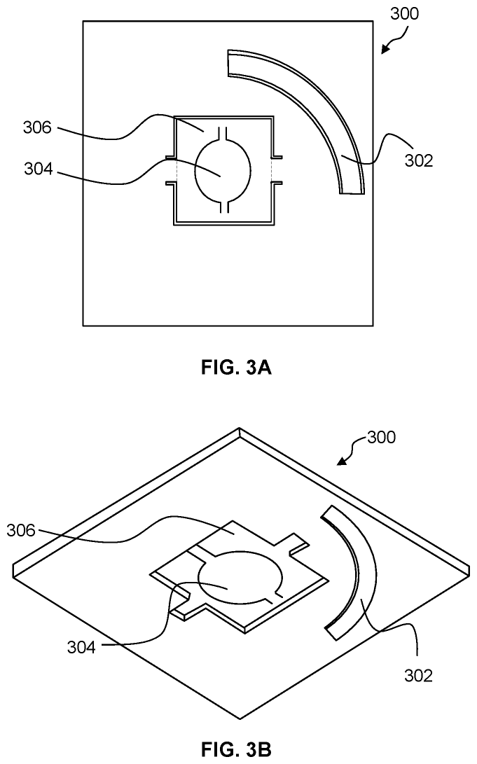

FIGS. 3A and 3B illustrate a top-view and a bottom auxiliary view respectively, of a second exemplary integration of a deflection device 300 that includes one or more trenches having actuator elements in accordance with an implementation of the present disclosure. The second exemplary integration of the deflection device 300 depicts a bridge structured piezo 302, a mirror 304, and a recess 306. The bridge structured piezo 302 enables additional movement freedom for the mirror 304 that achieves higher amplitudes. A resonance frequency of the bridge structured piezo 302 may be fitted to a resonance frequency of the mirror 304 by varying the size of the bridge structured piezo 302 and attaching an additional silicon mass. This enhances drive efficiency of the mirror 304. One or more bridge structured piezo 302 is optionally arranged as curved actuator elements. Each of the one or more bridge structured piezo 302 optionally covers a segment of circumference around the recess 306 to form actuator means.

The curved actuator elements may be arranged using a long bridge structured piezo electric element. The long bridge structured piezo electric element enables additional movement freedom for the mirror 304, which achieves higher amplitudes. Resonance frequency of a bridge structured actuator element may be fitted to the resonance frequency of the mirror 304 by varying the size of the long bridge structured piezo electric element and attaching an additional silicon mass element. The curved actuator elements achieve additional movement that realises a greater amplitude of the deflection device. The size of the curved actuator elements may be adjusted to achieve a drive frequency of the mirror 304. The additional silicon mass element may be added to the curved actuator elements.

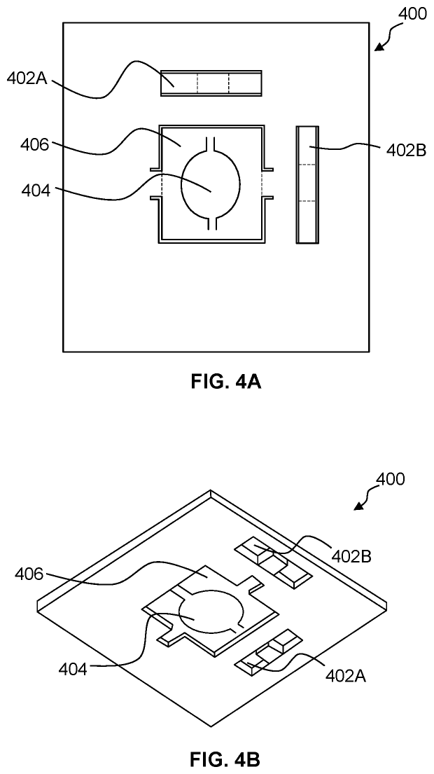

FIGS. 4A and 4B illustrate a top-view and a bottom auxiliary view respectively, of a third exemplary integration of a deflection device 400 that includes one or more trenches having actuator element in accordance with an implementation of the present disclosure. The third exemplary integration of the deflection device 400 includes one or more position optimized piezo 402A-B, a mirror 404, and a recess 406. The one or more position optimized piezo 402A-B may be a combination of the bridge structured piezo 302 and an additional silicon mass and has position optimization. The third exemplary integration of the deflection device 400 achieves the best drive efficiency of the mirror 404 by adjusting a resonance frequency of one or more actuators to a respective scanning axis of the one or more actuators based on a design, and, by selecting an optimal placement of the one or more actuators on the deflection device. One of the one or more position optimized piezo 402A-B is optionally used either to drive the mirror 404 or a gimbal structure on the third exemplary integration of the deflection device 400.

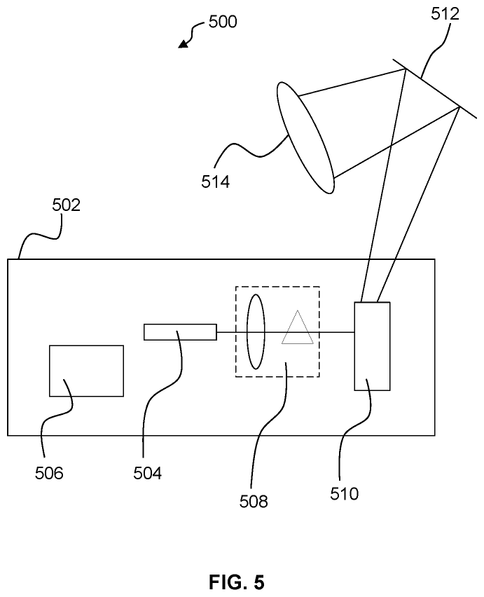

FIG. 5 is a schematic illustration of a product 500 that uses a deflection device 510 in accordance with an implementation of the present disclosure. The deflection device 510 may be any of the deflection device 100, the deflection device 200, the deflection device 300, or the deflection device 400 as described earlier. The product 500 may be an operating environment for the deflection device 510. The product 500 may include a light engine 502, a laser 504, a microcontroller 506, a set of optical elements 508, the deflection device 510, and a reflection surface 512. The laser 504 may be an RGB laser. The laser 504 may emit a laser ray that passes through the set of optical elements 508 to enter the deflection device 510. The deflection device 510 may project the laser ray to the reflection surface 512. The deflection device 510 may cause a visual to be created at a human eye 514. The product 500 may be used for (i) projection in augmented reality or virtual reality glasses or helmets, (ii) heads-up display projection, (iii) laser headlights, active scene or object lightning used to project information to a surface, or (iv) laser scanning in a light detection and ranging system.

In an example implementation, the light engine 502 includes a laser emitting device, the set of optical elements 508, and the deflection device 510 for use in an augmented reality or virtual reality (AR/VR) device. The set of optical elements 508 may include, but are not limited to, a prism. The set of optical elements may be arranged to shape a laser beam emitted from the laser emitting device. The set of optical elements 508 is optionally arranged to project the shaped laser beam onto a reflective surface to display an image to a user of the (AR/VR) device. The AR/VR device may be a laser headlight on an external surface. A laser scanning system in light detection and ranging (LiDAR) system may also incorporate the light engine 502.

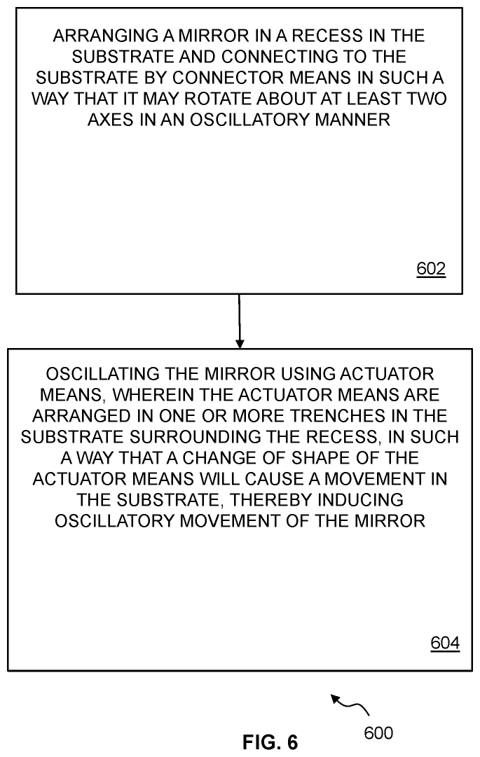

FIG. 6 is a flow-chart 600 that describes a method of externally exciting a mirror using an auxiliary internal piezo actuator placed beside a mirror structure in accordance with an implementation of the present disclosure. At step 602, the mirror is arranged in a recess in a substrate and connected to the substrate by connector means in such a way that it may rotate about at least two axes in an oscillatory manner. At step 604, the mirror is oscillated using actuator means. The actuator means are arranged in one or more trenches in the substrate surrounding the recess, in such a way that a change of shape of the actuator means will cause a movement in the substrate, thereby inducing oscillatory movement of the mirror.

Although the present disclosure and its advantages have been described in detail, it should be understood that various changes, substitutions and alterations can be made herein without departing from the spirit and scope of the disclosure as defined by the appended claims.

1. A deflection device for use in a scanner, the deflection device comprising:
a substrate,
a mirror arranged in a recess in the substrate and connected to the substrate by connector means in such a way that it can rotate about at least two axes in an oscillatory manner,
actuator means for causing the mirror to oscillate, wherein the actuator means are arranged in one or more trenches in the substrate surrounding the recess, in such a way that a change of shape of the actuator means will cause a movement in the substrate, thereby inducing oscillatory movement of the mirror.

2. The deflection device according to claim 1, wherein the mirror is a MEMS mirror.

3. The deflection device according to claim 1, wherein the actuator means are arranged to change its shape in response to an electrical signal.

4. The deflection device according to claim 3, wherein the actuator means comprises one or more piezo-electric elements controlled by a voltage signal.

5. The deflection device according to claim 3, wherein the actuator means comprises one or more electrostatic comb elements controlled by a voltage signal.

6. The deflection device according to claim 3, wherein the actuator means comprises one or more magnetic force stimulation elements controlled by a current signal.

7. The deflection device according to claim 1, wherein a mass element is arranged in under the actuator means in at least one of the one or more trenches.

8. The deflection device according to claim 1, wherein the connector means include one or more springs attached by one end to the mirror and the other end to the substrate surrounding the recess.

9. The deflection device according to claim 8, wherein a piezoelectric element is attached to at least one of the springs for detecting the orientation of the mirror and generating a signal representative of the orientation to a control means arranged to control the actuator means.

10. The deflection device according to claim 1, wherein the actuator means comprises four actuator elements positioned the corners of a rectangle around the recess.

11. The deflection device according to claim 1, wherein the actuator means comprises at least three curved actuator elements each covering a segment of a circumference around the recess.

12. A light engine for an augmented reality or virtual reality device, comprising a laser emitting device, one or more optical elements arranged to shape a laser beam emitted from the laser emitting device, a deflection device according to claim 1 arranged to project the shaped laser beam onto a reflection surface to display an image to a user of the augmented reality or virtual reality device.

13. A display device for augmented reality or virtual reality comprising one or more light engines according to claim 12.
